(19) United States
(12) Patent Application Publication
(10) Pub. No.: US 2006/0221470 A1
(43) Pub. Date: Oct. 5, 2006

(54) Optical disk device

(76) Inventor: Kenya Kurokawa, Tachikawa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/395,991

(22) Filed: Mar. 31, 2006

(30) Foreign Application Priority Data
Mar. 31, 2005 (JP) 2005-101588

(51) Int. Cl. G02B 7/02

(52) U.S. Cl. 359/814

(57) ABSTRACT

A focus control circuit controls focus of a laser light by using an objective lens actuator. A tracking control circuit controls tracking of the laser light by using the objective lens actuator. The lens actuator includes a fixed unit including two magnets; and a moving unit arranged between the two magnets and including the objective lens, a lens holder, a focus coil, and a tracking coil. The tracking coil is provided on the lens holder such that the position of a tracking coil center in a focus direction is located more toward the objective lens side than the position of a magnetic circuit center of each magnet in the focus direction.

### CROSS-REFERENCE TO RELATED APPLICATIONS

This application is based upon and claims the benefit of priority from Japanese Patent Application No. 2005-101588, filed Mar. 31, 2005, the entire contents of which are incorporated herein by reference.

### BACKGROUND

1. Field

The present invention relates to an optical disk device that records and reproduces information on/from an optical disk. More particularly, the present invention relates to an objective lens actuator that drives an objective lens for converging a laser light onto an optical disk, in a focus diction, a tracking direction, and a radial tilt direction.

2. Description of the Related Art

As is known, in recent years, high-density information recording technology has been advanced and an optical disk in which the storage capacity of a single layer on one side is 4.7 GB (Giga Bytes) has become available. Optical disks, such as a compact disk (CD), are generally known as information storage media. Examples of optical disks, other than a CD, include a digital versatile disk (DVD) and a high definition (HD)-DVD.

When information is recorded on or reproduced from an optical disk, the position and angle of an objective lens is controlled such that a laser beam is converged onto a recording surface of the disk, an optical beam spot follows information tracks on the disk, and even if the disk is warped, the laser beam is irradiated perpendicular to the recording surface of the disk.

Control of adjusting the position of the objective lens such that the laser beam is converged onto the recording surface of the disk is called a focus control. Control of adjusting the position of the objective lens such that the optical beam spot follows information tracks on the disk is called a tracking control. Control of adjusting the angle of the objective lens such that the laser beam is irradiated perpendicular to the recording surface of the disk is called a tilt control. These controls are performed using an objective lens actuator. With the advancement of high-density recording technology for information to be recorded on an optical disk, high lens driving accuracy of the objective lens actuator is becoming more and more demanded.

For magnets suitably used in an objective lens actuator, for the purpose of obtaining compact and light-weighted magnets, there exist multipolar magnetizing magnets. A multipolar magnetizing magnet is a magnet in which a plurality of split regions are provided and adjacent regions have opposite magnetization directions. An exemplary objective lens actuator that uses multipolar magnetizing magnets is shown in Jpn. Pat. Appln. KOKAI Publication No. 2004-139642.

In optical disks, such as an HD-DVD, that are intended to realize a higher recording density than that of conventional DVDs, an objective lens with a larger numerical aperture is used; therefore, the mass of the objective lens is larger than that of conventional DVDs. Use of an objective lens with a large mass produces unwanted resonance when the lens is driven and thus a servo band cannot be widened. This unwanted resonance can be suppressed by adjusting the position of tracking coils of a lens actuator.

In the case of the above-described Jpn. Pat. Appln. KOKAI Publication No. 2004-139642, for example, if the mounting position of tracking coils is changed, the mounting position of focus coils also needs to be changed, degrading the characteristics of the lens actuator. In addition, the number of tracking coils is as large as four, degrading the efficiency of coil power per unit of the amount of drive current.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration of an optical disk device to which the present invention is applied;

FIG. 2 is a perspective view showing the overall structure of an objective lens actuator 14;

FIG. 3 is a perspective view showing a structure of a moving unit 38 of the objective lens actuator 14;

FIG. 4 is a diagram showing a configuration of a magnetic circuit portion of an objective lens actuator according to an embodiment of the present invention;

FIG. 5 is a diagram showing a magnet magnetization pattern according to the embodiment of the present invention;

FIG. 6 is a diagram showing the disposition of two magnets according to the embodiment of the present invention;

FIG. 7 is a diagram showing the disposition of focus coils and a tracking coil;

FIG. 8 is a diagram for explaining the driving principle of the focus coils;

FIG. 9 is a diagram for explaining the driving principle of the tracking coils;

FIG. 10 is a diagram for explaining the driving principle of a radial tilt coil;

FIG. 11 is a view of a lens holder as viewed from the bottom;

FIG. 12 is a diagram showing an exemplary cross section of the lens holder;

FIG. 13 is diagrams showing measurement results of amplitude- and phase-frequency characteristics when the focus coils are driven; and

FIG. 14 is diagrams showing measurement results of amplitude- and phase-frequency characteristics when the tracking coils are driven.

### DETAILED DESCRIPTION

Various embodiments according to the invention will be described hereinafter with reference to the accompanying drawings. In general, according to one embodiment of the invention, there is provided an optical disk device comprises: an objective lens actuator which drives an objective lens in a focus direction and a tracking direction, the objective lens converging a laser light onto an information recording surface of an optical disk; a focus control unit which controls focus of the laser light by using the objective lens actuator; and a tracking control unit which controls tracking of the laser light by using the objective lens actuator, wherein the objective lens actuator comprises: a fixed unit including two magnets; and a moving unit arranged between the two magnets and including the objective lens, a lens holder, a focus coil, and a tracking coil, and the tracking coil is provided on the lens holder such that a position of a center B of the tracking coil in the focus direction is located more toward a side of the objective lens than a position of a center of a magnetic circuit of each magnet in the focus direction.

The reason for the occurrence of the above unwanted resonance when the lens is driven is that the center of gravity of the moving unit of the lens actuator is shifted to the lens side since an objective lens with a large mass is provided and the position of the point of action of the driving force of the tracking coils is offset from the center of gravity of the moving unit, producing unwanted torque in the moving unit.

With the above-described optical disk device configuration, the position of the point of action of the driving force of the tracking coils is at the center of gravity of the moving unit, and accordingly, unwanted torque is not produced in the moving unit.

Even when an objective lens with a large mass is used, unwanted resonance does not occur upon driving, making it possible to provide an optical disk device using an objective lens actuator with a wide servo band.

(1) Configuration of an Optical Disk Device

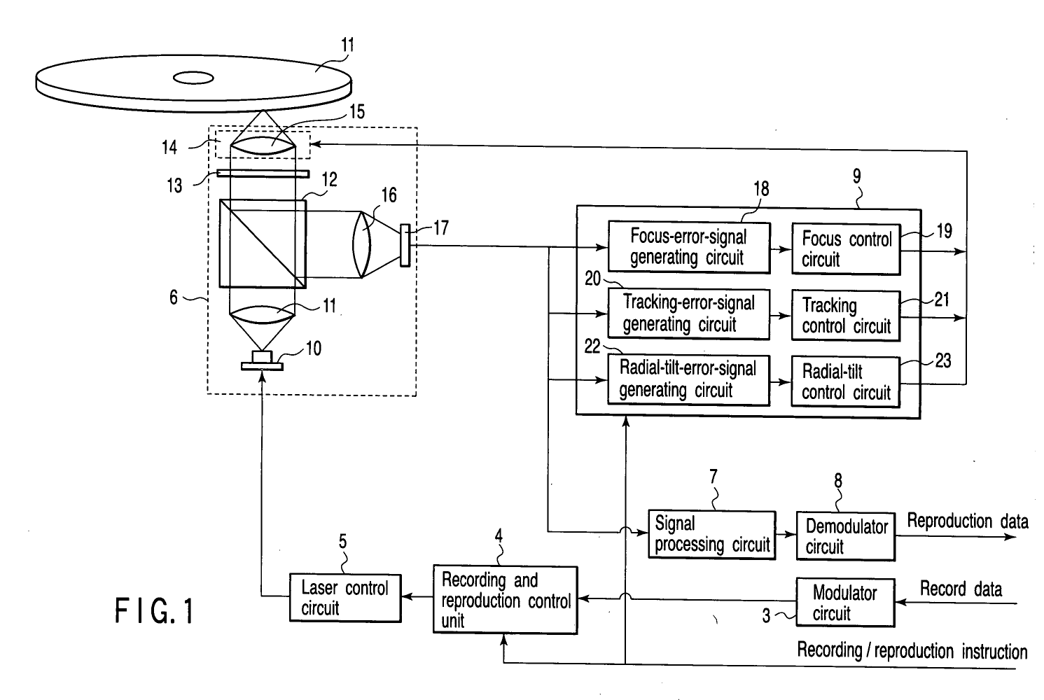

FIG. 1 is a block diagram showing a configuration of an optical disk device to which the present invention is applied. The optical disk device has a function of recording and reproducing information on/from an optical disk 1 such as a CD, a DVD, or an HD-DVD.

The optical disk device includes a modulator circuit 3, a recording and reproduction control unit 4, a laser control circuit 5, an optical head 6, a signal processing circuit 7, a demodulator circuit 8, and a lens actuator control unit 9.

The optical head 6 includes a semiconductor laser 10, a collimating lens 11, a PBS (Polarizing Beam Splitter) 12, a quarter-wave plate 13, an objective lens actuator 14, an objective lens 15, a condenser lens 16, and a photodetector 17.

The lens actuator control unit 9 includes a focus error signal generating circuit 18, a focus control circuit 19, a tracking error signal generating circuit 20, a tracking control circuit 21, a radial tilt error signal generating circuit 22, and a radial tilt control circuit 23.

First, recording of information on the optical disk 1 performed by the optical disk device will be described. The modulator circuit 3 modulates record data (data symbol) to be provided from a host based on a predetermined modulation method, to a channel bit sequence. The channel bit sequence corresponding to the record data is inputted to the recording and reproduction control unit 4.

A recording/reproduction instruction (a recording instruction in this case) is inputted to the recording and reproduction control unit 4 from the host. The recording and reproduction control unit 4 drives the optical head 6 such that an optical beam is appropriately converged at a target recording position. Furthermore, the recording and reproduction control unit 4 supplies the channel bit sequence to the laser control circuit 5.

The laser control circuit 5 converts the channel bit sequence into a laser drive waveform and drives the semiconductor laser 10. The laser control circuit 5 pulse drives the semiconductor laser 10. Along with this, the semiconductor laser 10 generates a recording optical beam corresponding to a desired bit sequence.

The recording optical beam generated from the semiconductor laser 10 is converted into parallel rays by the collimating lens 11 and enters the PBS 12 and then is transmitted through the PBS 12. The optical beam transmitted through the PBS 12 is transmitted through the quarter-wave plate 13 and is converged by the objective lens 15 onto an information recording surface of the optical disk 1.

The converged recording optical beam is subjected to a focus control by the focus control circuit 19 and the objective lens actuator 14, a tracking control by the tracking control circuit 21 and the objective lens actuator 14, and a radial tilt control by the radial tilt control circuit 23 and the objective lens actuator 14, whereby the recording optical beam is maintained in a state in which the best optical beam spot is obtained on the information recording surface of the optical disk 1.

Now, reproduction of information from the optical disk 1 performed by the optical disk device will be described. A recording/reproduction instruction (a reproduction instruction in this case) is inputted to the recording and reproduction control unit 4 from the host. In response to the reproduction instruction from the host, the recording and reproduction control unit 4 outputs a reproduction control signal to the laser control circuit 5.

The laser control circuit 5 drives the semiconductor laser 10 based on the reproduction control signal. Along with this, the semiconductor laser 10 generates a reproduction optical beam. The reproduction optical beam generated from the semiconductor laser 10 is converted into parallel rays by the collimating lens 11 and enters the PBS 12 and then is transmitted through the PBS 12. The optical beam transmitted through the PBS 12 is transmitted through the quarter-wave plate 13 and is converged by the objective lens 15 onto the information recording surface of the optical disk 1.

The converged reproduction optical beam is adjusted by the focus control circuit 19, the tracking control circuit 21, the radial tilt control circuit 23, and the objective lens actuator 14, such that the best optical beam spot is obtained on the information recording surface of the optical disk 1.

The reproduction optical beam irradiated onto the optical disk 1 is reflected by a reflecting film or reflective recording film under the information recording surface. The reflected light is transmitted through the objective lens 15 in a backward direction and converted into parallel rays again and then transmitted through the quarter-wave plate 13 and thereafter reflected off the PBS 12 having polarization perpendicular to incident light.

The optical beam reflected off the PBS 12 is converted into converging rays by the condenser lens 16 and then enters the photodetector 17. The photodetector 17 is composed of a four-split photodetector, for example. Photoelectrical conversion is performed to convert the bundle of rays having entered the photodetector 17 into an electrical signal and the electrical signal is amplified. The amplified signal is equalized and binarized by the signal processing circuit 7 and sent to the demodulator circuit 8. The demodulator circuit 8 performs a demodulation operation corresponding to a predetermined modulation method on the signal and then outputs reproduction data.

In addition, based on part of the electrical signal outputted from the photodetector 17, a focus error signal is generated by the focus error signal generating circuit 18. Similarly, based on part of the electrical signal outputted from the photodetector 17, a tracking error signal is generated by the tracking error signal generating circuit 20. Similarly, based on part of the electrical signal outputted from the photodetector 17, a radial tilt error signal is generated by the radial tilt error signal generating circuit 22.

The focus control circuit 19 controls the objective lens actuator 14 based on the focus error signal and controls the focus of a beam spot. The tracking control circuit 21 controls the objective lens actuator 14 based on the tracking error signal and controls the tracking of the beam spot. The radial tilt control circuit 23 controls the objective lens actuator 14 based on the radial tilt error signal and controls the radial tilt of the beam spot.

(2) Overall Configuration of the Objective Lens Actuator

The objective lens actuator 14 according to an embodiment of the present invention will be described.

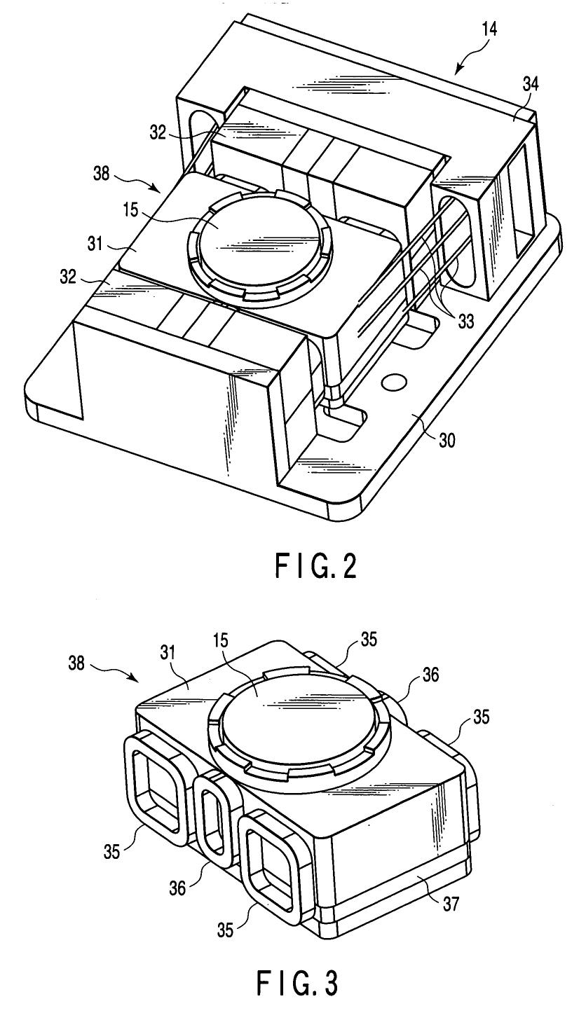

FIG. 2 is a perspective view showing the overall structure of the objective lens actuator 14 and FIG. 3 is a perspective view showing a structure of a moving unit 38 of the objective lens actuator 14. A lens holder 31 having mounted thereon an objective lens 15, focus coils 35, and tracking coils 36 is supported by six suspension wires 33 provided at both sides of the lens holder 31. The suspension wires 33 pass through a gel box 34 in which a damping material is put, and is fixed by a substrate bonded to the gel box 34. Through the suspension wires 33, power is supplied to coils of the moving unit 38 from an external power source.

By a magnetic field generated by a current flowing through the coils and a magnetic flux generated by two magnets 32 which are fixed to a yoke base 30 so as to sandwich the moving unit 38, a Lorentz force acts on the coils, whereby the objective lens 15 is driven in a focus, tracking, or radial tilt direction. The yoke base 30, the two magnets 32, and the gel box 34 compose a fixed unit.

In the case of a high-density recording optical disk, such as an HD-DVD, on which the present invention focuses, an objective lens with a large numerical aperture needs to be used. The element and shape of the objective lens 15 are determined so as to achieve a large numerical aperture, and therefore, the mass of the objective lens 15 is larger than that of conventional objective lenses.

(3) Magnetic Circuit Portion

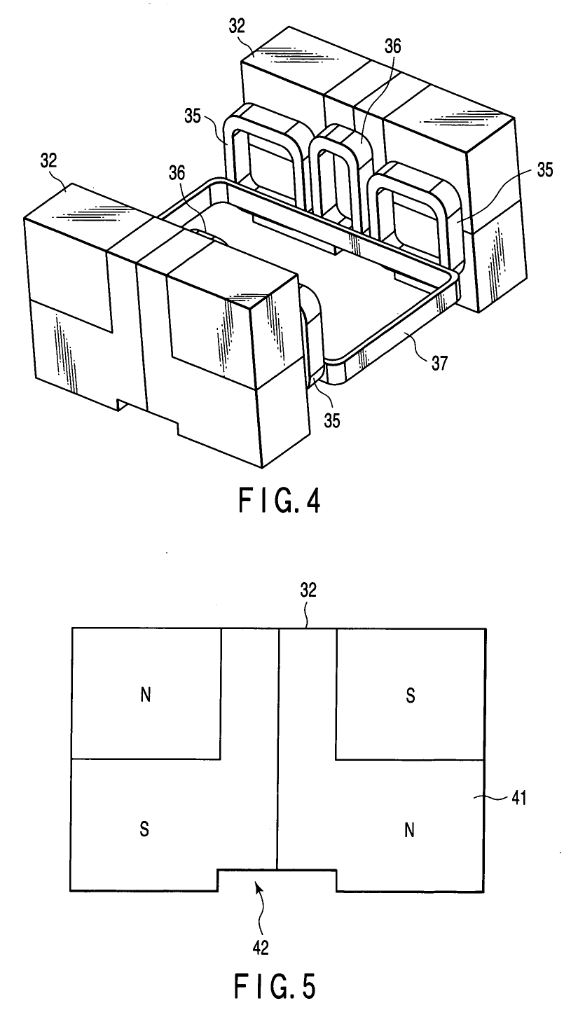

FIG. 4 is a diagram showing a configuration of a magnetic circuit portion, i.e., magnets and coils, of an objective lens actuator according to the embodiment of the present invention. Two magnets 32 are fixed onto the yoke base 30 so as to sandwich the moving unit 38 of FIG. 2. Each magnet 32 is magnetically split into four regions, as will be described later, and adjacent regions have opposite polarities. As shown in FIG. 4, two focus coils 35 and one tracking coil 36 are arranged for each magnet 32 so as to face their corresponding magnet 32. A radial tilt coil 37 is arranged so as to go around the periphery of the objective lens 15 and the lens holder 31.

(4) Magnet Magnetization

Magnet magnetization is performed such that, as shown in FIG. 5, a single magnet 32 is split into four regions and adjacent regions have opposite polarities. The magnetization direction is a direction perpendicular to a region-split surface 41 (a surface shown in FIG. 5) of the magnet 32. The reason that the magnet 32 is not in the shape of a rectangular parallelepiped but has a depressed surface 42 provided at its bottom center which is on the yoke base side will be described later.

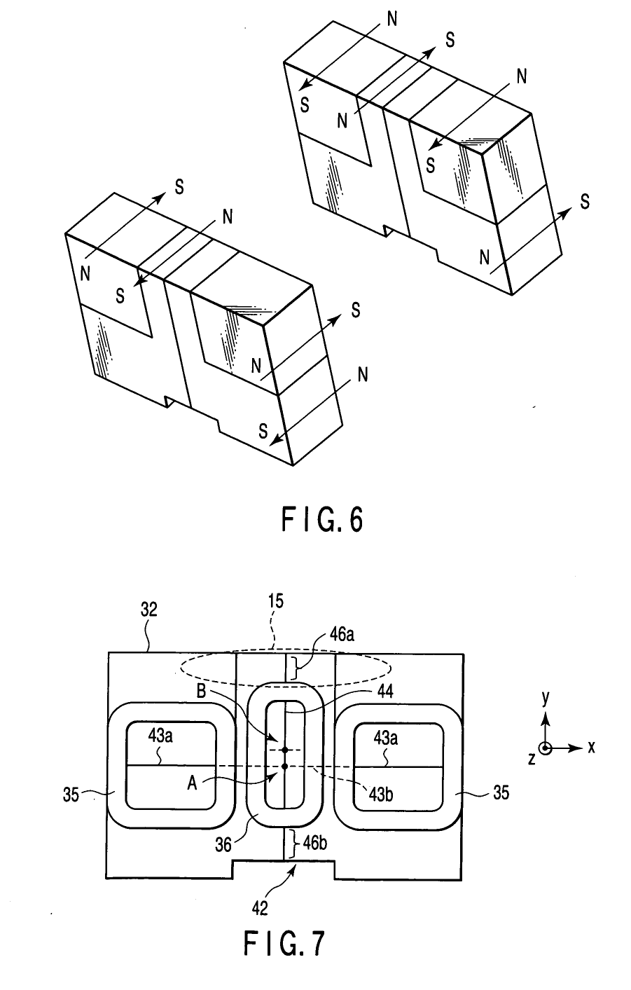

Due to the condition of driving the radial tilt coil, the magnets 32 need to be arranged in the manner shown in FIG. 6. The two magnets 32 employ exactly the same method for splitting regions, however, have opposite polarities and thus need to be manufactured separately.

(5) Disposition of Focus Coils and Tracking Coils

FIG. 7 is a diagram showing the disposition of focus coils 35 and a tracking coil 36. By passing a current through the focus coils 35, the moving unit 38 moves in a y-axis direction (a focus direction). By passing a current through the tracking coil 36, the moving unit 38 moves in an x-axis direction (a tracking direction). In this manner, the moving unit 38 is driven and moves in the y-axis direction (the focus direction) and the x-axis direction (the tracking direction), but is not driven or moves in a z-axis direction. Hence, in the following description, the description of the z-axis direction is omitted.

An intersection point A of a line 43b of the magnet 32 including horizontal magnetization region borderlines 43a, and a vertical magnetization region borderline 44 at the center of the magnet indicates the center of a magnetic circuit of the magnet 32. The focus coils 35 are arranged on the left and right sides of the magnet 32 so as to cross the horizontal borderlines 43a of the magnet 32. The center of the focus coils 35 is at the position of the borderlines 43a in the focus direction (the y-axis direction). The tracking coil 36 is arranged so as to cross the borderline 44 at the center of the magnet. A center B of the tracking coil 36 is at the position of the borderline 44 in the tracking direction (the x-axis direction).

As in the present embodiment, by mounting the objective lens 15 with a larger mass than that of conventional ones, the center of gravity of the moving unit 38 is shifted to the side of the objective lens 15 in an optical axis direction (the y-axis direction). The magnetic circuit center A of the magnet 32 corresponds to the center of gravity of the moving unit for the case in which a conventional relatively lightweight objective lens is mounted on the moving unit. The center B of the tracking coil 36 corresponds to the center of gravity of the moving unit for the case in which an objective lens 15 with a large mass is mounted on the moving unit. In order to cope with such a change in the center of gravity, the tracking coil 36 is arranged so as to be shifted to the side of the objective lens 15 from a conventional position. By doing so, the center of gravity of the moving unit is at the point of action of the driving force of the tracking coils (the center of the tracking coils). Specifically, the tracking coils 36 are provided on the lens holder such that the position of the tracking coil center B in the focus direction (the y-axis direction) is shifted to the objective lens side from the position of the magnetic circuit center A of the two magnets in the focus direction.

A groove 42 of the magnet 32 is provided such that a distance 46a from an upper end of the tracking coil to an upper end of the magnet is the same as a distance 46b from a lower end of the tracking coil to a lower end of the magnet. By the groove 42, the Lorentz force acting on the tracking coil 36 becomes of the same magnitude between the upper side (the side of the objective lens 15) and lower side of the tracking coil 36, preventing unwanted tilt.

(6) Driving Principle of the Focus Coils

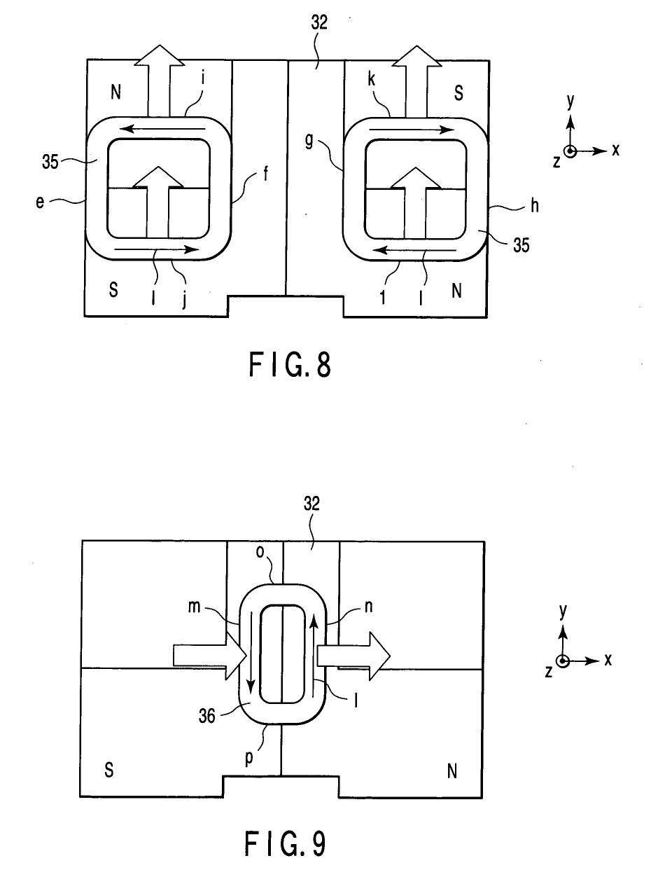

FIG. 8 is a diagram for explaining the driving principle of the focus coils 35. Passing a current I in directions shown in FIG. 8 through the focus coils 35 will be considered. The direction of a magnetic field generated by a magnet 32 facing the focus coils 35 is a z-axis direction (a direction perpendicular to the paper) which is perpendicular to the winding direction of the coils. The direction of the magnetic field is toward the coils at the N pole and toward the magnet 32 at the S pole.

When Fleming's left-hand rule is applied to this model, Lorentz forces which are all in a vertical-up direction as shown by thick arrows, act on four sides i, j, k, and l parallel to a horizontal direction (an x direction) in the left and right focus coils 35 of FIG. 8. Note that although Lorentz forces in the horizontal direction are also generated in four sides e, f, g, and h parallel to a vertical direction (a y-axis direction), these forces cancel each other and thus are negligible as compared with the Lorentz forces acting in the vertical-up direction. By this principle, the moving unit 38 can be driven in the focus direction. Note that although in FIG. 8 the magnetic field of focus coils 35 and a magnet 32 on one side is considered, the same disposition is used for focus coils 35 and a magnet 32 located on the other side of the focus coils 35 and the magnet 32 on the one side from the objective lens 15 and the lens holder 31, and by exactly the same principle the driving force in the focus direction can be generated.

(7) Driving Principle of the Tracking Coils

FIG. 9 is a diagram for explaining the driving principle of the tracking coils 36. Passing a current I in a direction shown in FIG. 9 through the tracking coil 36 will be considered. The direction of a magnetic field generated by a magnet 32 facing the tracking coil 36 is a z-axis direction which is perpendicular to the winding direction of the coil. The direction of the magnetic field is toward the coil at the N pole and toward the magnet 32 at the S pole.

When Fleming's left-hand rule is applied to this model, in the tracking coil 36 of FIG. 9, Lorentz forces which are all in a horizontal-right direction as shown by thick arrows, act on two sides m and n parallel to a vertical direction (a y-axis direction). Note that although Lorentz forces in the vertical direction are also generated in two sides o and p parallel to a horizontal direction (an x-axis direction), these forces cancel each other and thus are negligible as compared with the Lorentz forces acting in the horizontal-right direction. By this principle, the moving unit 38 can be driven in the tracking direction. Note that although in FIG. 9 the magnetic field of a tracking coil 36 and a magnet 32 on one side is considered, the same disposition is used for a tracking coil 36 and a magnet 32 across the objective lens 15 and the lens holder 31, and by exactly the same principle the driving force in the tracking direction can be generated.

(8) Driving Principle of the Radial Tilt Coil

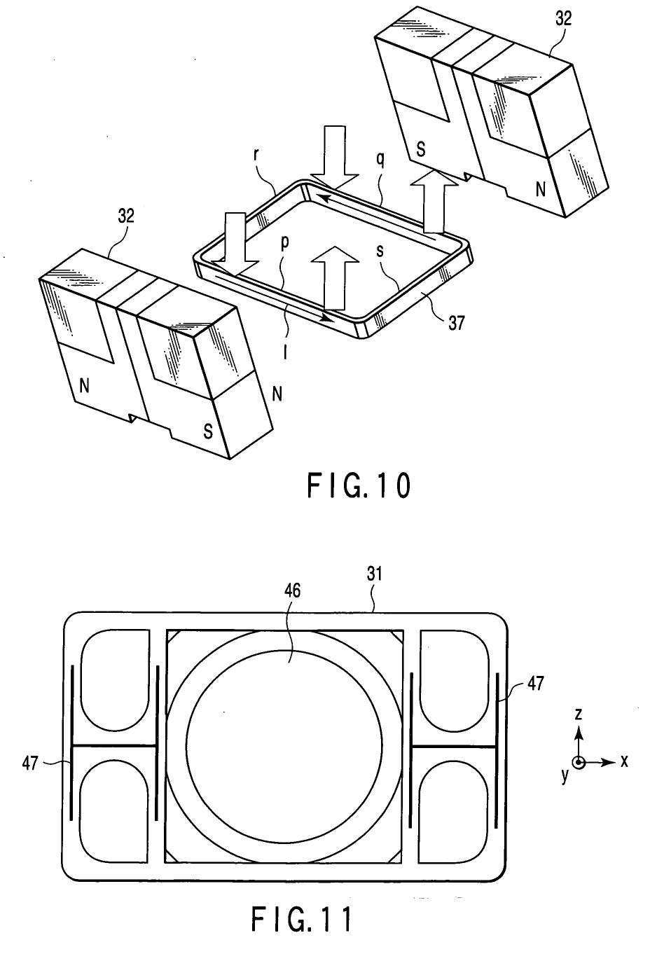

FIG. 10 is a diagram for explaining the driving principle of the radial tilt coil 37. The radial tilt coil 37 is directly wound on the lens holder 31 between the two magnets 32 so as to encompass the objective lens 15 and the lens holder 31 (see FIG. 3). In FIG. 10, in sides q and p of the radial tilt coil 37 parallel to magnet sides, magnetic fields in opposite directions act on the right and left sides of each side in the drawing by means of the magnetization pattern of the magnets 32. In this state, passing a current I through the coil in a direction shown in FIG. 10 is considered. From the direction of the magnetic field and the direction of the current, Lorentz forces in opposite direction, one up and one down, are generated on the right and left sides respectively of each of the sides p and q of the radial tilt coil 37 parallel to the magnets 32 by Fleming's left-hand rule, as shown by thick line arrows. These forces become a couple and a torque that tilts the moving unit 38 in the radial tilt direction can be produced.

The radial till coil 37 is mounted on the lower side of the lens holder 31. Specifically, with the side where the objective lens 15 of the moving unit 38 is provided being the upper side, the radial tilt coil 37 is provided only on the lower side of the moving unit 38 in the focus direction than the magnetic circuit center A of each magnet 32 (see FIG. 7). This is because the radial tilt coil 37 does not require as much driving force as the focus coils 35 or the tracking coils 36 do. In order to suppress the offset from the center of gravity caused by mounting the heavy objective lens 15, the radial tilt coil 37 uses a coil with a large density made of copper and is mounted on the lower side of the lens holder 31.

The mass of the tracking coils 36 is far smaller than that of the radial tilt coil 32. Therefore, even if the tracking coils 36 are moved upward in the y-axis direction, as in the present embodiment, the center of gravity of the moving unit 38 does not change much. However, if the position of the radial tilt coil 32 is changed, the center of gravity changes according to the change. Thus, although the center of gravity of the moving unit 38 is shifted to the lens side by mounting the heavy objective lens 15, such a shift can be suppressed by mounting the radial tilt coil 37 with a large mass on the lower side of the lens holder 31.

Hence, when an objective lens with a large mass is mounted on the moving unit 38, the point of action B of the driving force of the tracking coils is moved upward by moving the tracking coils 36 upward as shown in, for example, FIG. 7. If the center of gravity of the moving unit is not sill at the point of action B even by moving the point of action of the driving force of the tracking coils upward in this manner, a radial tilt coil 37 with a large mass may be mounted on the lower side of the lens holder 31 to position the center of gravity of the moving unit at the point of action B.

In general, when an objective lens 15 is driven in the focus direction and the tracking direction in an objective lens actuator, a force in an unwanted direction acts on coils in a magnetic circuit including magnets and coils, causing a phenomenon that the objective lens is tilted in the unwanted direction. In the magnetic circuit according to the present invention, however, the tilt of the objective lens is minimized by adjusting the magnetization pattern of the magnets 32 and the disposition of the focus coils 35 and the tracking coils 36, as described above.

As described above, in the present embodiment, the tracking coils 36 is arranged more toward the disk side than the center of the magnetic circuit in an objective lens actuator. Consequently, even when the objective lens 15 with a large mass is mounted, the center of the driving force cannot be offset from the center of gravity of the moving unit 38 of the actuator, preventing unwanted resonance.

(9) Internal Structure of the Lens Holder

FIG. 11 is a view of the lens holder 31 as viewed from the bottom. As shown in FIG. 11, at the bottom of the lens holder 31, a mounting hole (a hole through which a beam passes) 46 for the objective lens 15 has, at both sides, an H-shaped rib structure which is resistant to bending, achieving both a reduction in weight and an increase in stiffness.

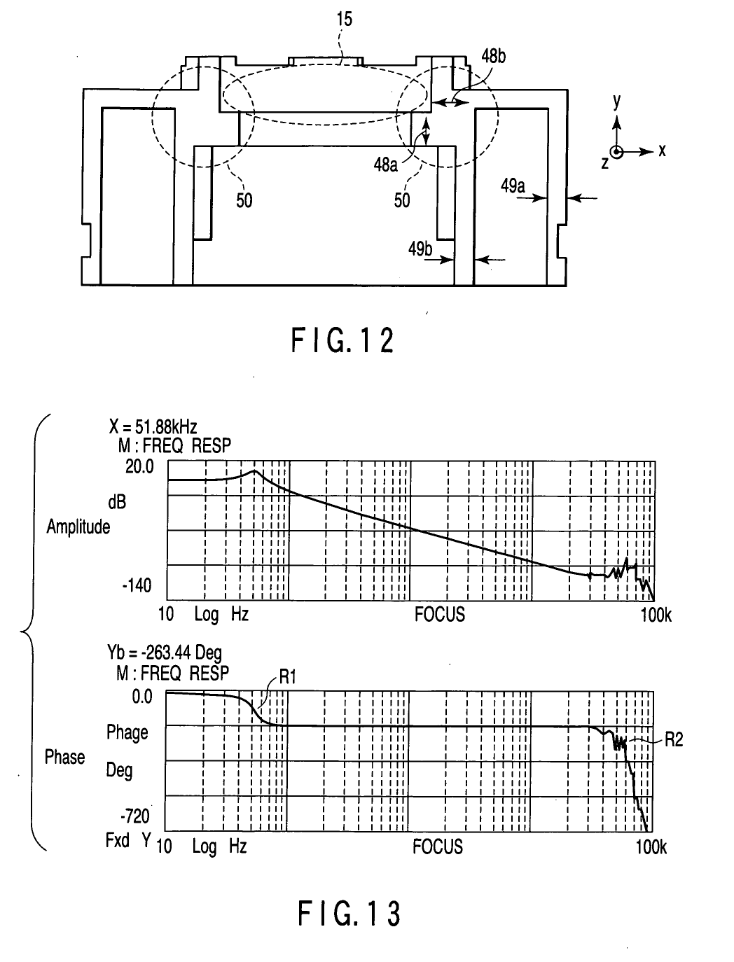

FIG. 12 is a diagram showing an exemplary cross section of the lens holder 31. By increasing wall thicknesses 48a and 48b of walls of a portion 50 where the objective lens 15 is mounted, unwanted vibration of the objective lens 15 is suppressed even when a heavy-weight lens is mounted. The wall thicknesses 48a and 48b are thicker than the wall thicknesses of other walls, such as a wall thickness 49a of an outer wall or a wall thickness 49b of an inner wall, by, for example, 1.5 mm to 2.5 mm, preferably by about 2 mm.

(10) Measures Against Resonance

As shown in FIG. 11, the lens holder 31 has, at its both sides, H-shaped ribs 47. The ribs allow the frequency of higher-order resonance (a band of several tens of kHz) in the focus direction caused by elastic deformation of the lens holder 31 itself, to be shifted to the high frequency side, thereby widening the servo band. As shown in FIG. 12, the objective lens 15 is mounted on the lens holder 31 so as to be slightly embedded, and furthermore, the wall thickness of a portion of the lens holder near the objective lens mounting portion 50 is thicker than that of other walls. The structure of the lens mounting portion also allows the frequency of higher-order resonance to be shifted to the high frequency side, thereby widening the servo band. Furthermore, by changing the mounting position of the tracking coils 36 to the upper position, the offset of the center of gravity of the moving unit from the point of action of the driving force is eliminated. Accordingly, the occurrence of a secondary resonance in the tracking direction and at a band of several tens of kHz caused by such an offset is prevented.

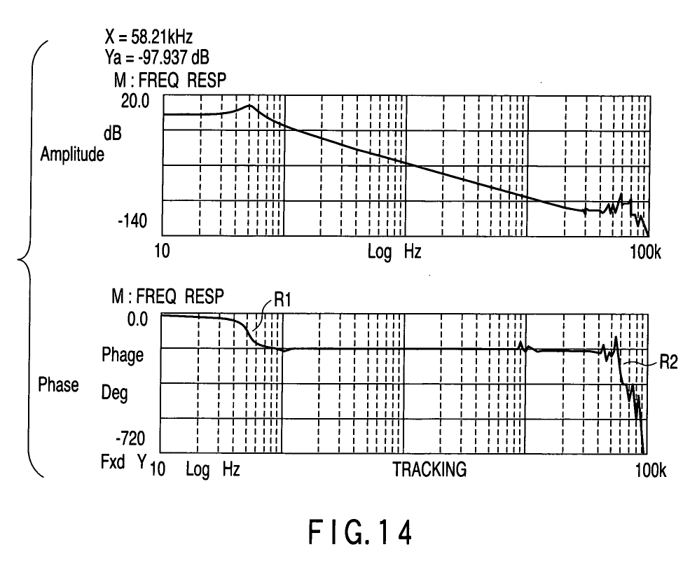

FIGS. 13 and 14 are diagrams showing results obtained by prototyping and evaluating the objective lens actuator 14.

FIG. 13 is a diagram showing measurement results of amplitude (the amount of movement)- and phase-frequency characteristics of the moving unit 38 when the focus coils are driven. R1 represents a first-order resonance which is a resonance caused by the suspension wires 33 and the moving unit 38. R2 represents a second-order resonance (the above-described higher-order resonance) which is a resonance caused by the objective lens 15 and the lens holder 31. By passing a drive current with a high frequency through the coils, the lens holder is deformed to be bowed with the objective lens as the center and a phase shift occurs between the drive current and the objective lens. The second-order resonance R2 indicates the occurrence of such a phase shift.

When the frequency of the lens drive current becomes the second-order resonance frequency, the phase of the drive current and the phase of the objective lens are reversed from each other. A focus servo is performed generally in a frequency band from the first-order resonance R1 to the second-order resonance R2. In the present embodiment, in order to suppress the phase shift between the drive current and the objective lens, the H-shaped ribs 47 are provided at the bottom of the lens holder 31 as described above, and thus the frequency of the second-order resonance is higher than that conventionally obtained. As shown in FIG. 13, it can be seen that in a lens actuator according to the present invention a large secondary resonance is not present and stable frequency characteristics are achieved in a range of 40 Hz to 50 kHz.

FIG. 14 is a diagram showing measurement results of amplitude- and phase-frequency characteristics when the tracking coils are driven. A tracking servo is similarly performed in a frequency band from a first-order resonance R1 to a second-order resonance R2. In the present embodiment, in order to suppress the phase shift between the drive current and the objective lens when the tracking coils are driven, the frequency of the second-order resonance is higher than that conventionally obtained by increasing the wall thickness of a wall of the lens holder near the objective lens mounting portion as described above. As shown in FIG. 14, it can be seen that in a lens actuator according to the present invention a large secondary resonance is not present even when the tracking coils are driven and stable frequency characteristics are achieved in a range of 40 Hz to 50 kHz.

As described above, according to the present embodiment, the weight of the lens holder 31 in an objective lens actuator is reduced and stiffness thereof is increased, whereby the higher-order (mainly second-order) resonance frequency is high and the servo band of the objective lens actuator is wide even when an objective lens actuator with a large mass is mounted.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk device comprising:
an objective lens actuator which drives an objective lens in a focus direction and a tracking direction, the objective lens converging a laser light onto an information recording surface of an optical disk;
a focus control unit which controls focus of the laser light by using the objective lens actuator; and
a tracking control unit which controls tracking of the laser light by using the objective lens actuator,
wherein the objective lens actuator comprises:
a fixed unit including two magnets; and
a moving unit arranged between the two magnets and including the objective lens, a lens holder, a focus coil, and a tracking coil, and
the tracking coil is provided on the lens holder such that a position of a center of the tracking coil in the focus direction is located more toward a side of the objective lens than a position of a center of a magnetic circuit of the magnets in the focus direction.

2. The optical disk device according to claim 1, wherein each surface of the lens holder facing the magnet has one tracking coil and two focus coils provided at both sides of the tracking coil, and the focus coils and the tracking coil are provided on the lens holder such that a central position of the tracking coil is located more toward the objective lens side than a central position of the two focus coils.

3. The optical disk device according to claim 1 or 2, wherein each magnet has a plurality of split regions, adjacent regions are magnetized so as to have opposite NS polarities, and a magnetization direction is a direction orthogonal to the focus direction and the tracking direction.

4. The optical disk device according to claim 3, wherein the focus coil is provided on the moving unit such that a position of a center of the focus coil in the focus direction is at the position of the center of the magnetic circuit of the magnets in the focus direction.

5. The optical disk device according to claim 1, wherein a tilt coil is further provided on the moving unit, and with a side where the objective lens of the moving unit is provided being an upper side in the focus direction, the tilt coil is provided only on a lower side of the moving unit than the position of the center of the magnetic circuit of the magnets in the focus direction.

6. The optical disk device according to claim 1, wherein a wall thickness of a wall of the lens holder near a mounting portion of the objective lens is thicker than wall thicknesses of other walls of the lens holder.

7. An optical disk device comprising:
an objective lens actuator which drives an objective lens in a focus direction, a tracking direction, and a radial tilt direction, the objective lens converging a laser light onto an information recording surface of an optical disk;
a focus control unit which controls focus of the laser light by using the objective lens actuator;
a tracking control unit which controls tracking of the laser light by using the objective lens actuator; and
a radial tilt control unit which controls a radial tilt of the laser light by using the objective lens actuator,
wherein the objective lens actuator comprises:
a fixed unit including two magnets; and
a moving unit arranged between the two magnets and including the objective lens, a lens holder, a focus coil, a tracking coil, and a radial tilt coil, and
the objective lens is provided on an upper side of the moving unit in the focus direction, and the tilt coil is provided only on a lower side of the moving unit than a position of a center of a magnetic circuit of the magnets in the focus direction.

8. The optical disk device according to claim 7, wherein the tilt coil is directly wound on the lens holder.

9. An optical disk device comprising:
an objective lens actuator which drives an objective lens in a focus direction and a tracking direction, the objective lens converging a laser light onto an information recording surface of an optical disk;
a focus control unit which controls focus of the laser light by using the objective lens actuator; and
a tracking control unit which controls tracking of the laser light by using the objective lens actuator,
wherein the objective lens actuator comprises:
a fixed unit including two magnets; and
a moving unit arranged between the two magnets and including the objective lens, a lens holder, a focus coil, and a tracking coil, and
a wall thickness of a wall of the lens holder near a mounting portion of the objective lens is thicker than wall thicknesses of other walls of the lens holder.

10. The optical disk device according to claim 9, wherein with a side of the objective lens of the lens holder being an upper side, a bottom of the lens holder has a rib structure.
